(19) United States
(12) Patent Application Publication
(10) Pub. No.: US 2022/0164399 A1
(43) Pub. Date: May 26, 2022

(54) LOCATING METHOD AND DEVICE, AND STORAGE MEDIUM

(71) Applicants: BEIJING JINGDONG SHANGKE INFORMATION TECHNOLOGY CO., LTD., Beijing (CN); BEIJING JINGDONG CENTURY TRADING CO., LTD., Beijing (CN)

(72) Inventor: Wenyuan XIONG, Beijing (CN)

(21) Appl. No.: 17/425,814

(22) PCT Filed: Dec. 24, 2019
(86) PCT No.: PCT/CN2019/128084

§ 371 Date: Jul. 26, 2021

(30) Foreign Application Priority Data
Feb. 28, 2019 (CN) 201910151389.2

(51) Int. Cl. G06F 16/954; G06F 16/957; G06F 16/955; G06F 3/0482; G06F 3/0485

(52) U.S. Cl. CPC G06F 16/954; G06F 16/9574; G06F 3/0485; G06F 3/0482; G06F 16/9558

(57) ABSTRACT

A locating method and device, and a storage medium. The method comprises: displaying a locating control provided with a navigation point at a first preset position on a display interface loading list data, wherein the navigation point represents an identifier corresponding to a position marked in a loaded data link in the list data (S101); when a first locating operation acting on the navigation point is received, determining a corresponding position of first data to be located in the loaded data link (S102); jumping to the position of said first data on the display interface, and displaying said first data corresponding to the position of said first data, so as to implement locating of said first data on the display interface (S103).

### CROSS-REFERENCE TO RELATED APPLICATION

The Application is based upon and claims priority to Chinese Patent Application No. 201910151389.2, filed on Feb. 28, 2019, the disclosure of which is hereby incorporated by reference in its entirety.

### TECHNICAL FIELD

The disclosure relates to an information processing technology in the field of computer, and in particular, to a locating method and device, and a storage medium.

### BACKGROUND

Data is usually presented through a client in the form of a list, so the data presented is called list data. When the list data corresponds to a large number of records, it is usually presented by loading the records page by page or display the records page by page. Thus, it is hard to quickly view the data of interest after the list data that has been browsed due to the large amount of list data.

At present, when the record of interest in the browsed list data is located, the record of interest is usually added to another page, which is separate from a page displaying the list data, during browsing. In such case, it is needed to switch from the page displaying the list data to the another page to view the data of interest. Because there is power consumption in page switching, and the page switching increases the complexity of viewing the data of interest, the traditional art has high power consumption and high complexity when the data of interest in the browsed list data is viewed.

### SUMMARY

In order to solve the above technical problems, embodiments of the disclosure are intended to provide a locating method and device, and a storage medium, which can quickly locate the data of interest in browsed list data on a display interface on which list data is loaded with low power consumption and low complexity.

A technical solution of the disclosure is implemented as follows.

In a first aspect, the embodiments of the disclosure provide a locating method, which is applied to a locating device and may include the following operations.

A locating control, which is provided with a navigation point, at a first preset position is displayed on a display interface on which list data is loaded. The navigation point represents an identifier corresponding to a position marked in a loaded data link in the list data.

When a first locating operation acting on the navigation point is received, a corresponding position of first data to be located is determined in the loaded data link.

Jumping to the position of the first data to be located is performed on the display interface, and the first data to be located corresponding to the position of first data to be located is displayed to locate the first data to be located on the display interface.

In the above solution, before the locating control provided with the navigation point at the first preset position is displayed on the display interface where the list data is loaded, the method may further include the following operations.

Information of a position to be located is obtained. The information of the position to be located represents a distance between data marked in the loaded data link and a target point.

Each piece of position information corresponding to the information of the position to be located is taken as a position identifier to obtain the navigation point.

In the above solution, the information of the position to be located includes at least one of marked position information, position information of a list data group or recommended position information.

In the above solution, when the information of the position to be located is the marked position information, before the information of the position to be located is obtained, the method may further include the following operation.

A marking control is displayed at the corresponding position of each datum in the loaded data link on the display interface.

Correspondingly, that the information of the position to be located is obtained may include the following operations.

When a triggering operation acting on at least one of the marking controls is received, at least one corresponding marked datum is obtained according to at least one of the triggering operations.

The distance between the at least one marked datum and the target point is taken as the marked position information.

The marked position information is taken as the information of the position to be located.

In the above solution, when the information of the position to be located is the position information of a list data group, before the information of the position to be located is obtained, the method may further include the following operation.

The list data is divided into at least one group of data according to a preset loading rule.

Correspondingly, that the information of the position to be located is obtained may include the following operations.

Identification data of each group of data in the loaded data link is obtained.

The distance between the at least one of the identification data and the target point is taken as the position information of a list data group.

The position information of a list data group is taken as the information of the position to be located.

In the above solution, when the information of the position to be located is the recommended position information, that the information of the position to be located is obtained may include the following operations.

When a data loading request for the list data is received, feature information of the corresponding data requester is obtained.

The feature information of the data requester is input into a preset marking model to obtain list recommending position information corresponding to the list data. The preset marking model is used for determining a position information of a recommended mark in the list data.

Corresponding recommended data is obtained from the list recommending position information according to the loaded data link on the display interface.

The distance between the recommended data and the target point is taken as the recommended position information.

The recommended position information is taken as the information of the position to be located.

In the above solution, before the feature information of the data requester is input into the preset marking model to obtain the list recommending position information corresponding to the list data, the method may further include the following operations.

Historical mark information corresponding to the list data is obtained. The historical mark information represents information associated with a historical marking operation acting on the marking control and corresponding to the list data.

The corresponding historical marked position information and the feature information of a marking participant is obtained according to the historical marking information.

According to the historical marked position information and the feature information of the marking participant, a model is trained to obtain the preset marking model.

In the above solution, after the locating control provided with the navigation point at the first preset position is displayed on the display interface where the list data is loaded, the method may further include the following operations.

When a second locating operation acting on a non-navigational point of the locating control is received, a corresponding position of second data to be located is determined in the loaded data link. The non-navigational point represents information on a position on the locating control other than a navigation point.

Jumping to the position of the second data to be located is performed on the display interface, and the second data to be located corresponding to the position of second data to be located is displayed to locate the second data to be located on the display interface.

In the above solution, when the second locating operation is a first sliding operation, that when the second locating operation acting on the non-navigational point of the locating control is received, the corresponding position of the second data to be located is determined in the loaded data link may include the following operation.

When the first sliding operation acting on the non-navigational point of the locating control is received, a corresponding first data sliding track is determined in the loaded data link. The first data sliding track is the position of the second data to be located.

Correspondingly, that jumping to the position of the second data to be located is performed on the display interface, and the second data to be located corresponding to the position of second data to be located is displayed to locate the second data to be located on the display interface may include the following operations.

A data sliding start position and a data sliding end position of the first data sliding track are determined.

Jumping to the data sliding start position is performed on the display interface and the data is slid until the data reaches the data sliding end position, and the second data to be located corresponding to the first data sliding track is displayed to locate the second data to be located on the display interface.

In the above solution, after the locating control provided with the navigation point at the first preset position is displayed on the display interface where the list data is loaded, the method may further include the following operations.

A display operation acting on the navigation point is received.

According to the display operation, a prompt box is displayed at a second preset position on the display interface. The second preset position represents a position corresponding to the navigation point on the display interface, and the prompt box represents information of the loaded data link corresponding to the navigation point.

In the above solution, after the locating control provided with the navigation point at the first preset position is displayed on the display interface where the list data is loaded, the method may further include the following operations.

A second data sliding track of the loaded data link on the display interface is obtained.

A locating sliding track is determined on the locating control according to the second data sliding track.

A locating sliding start position and a locating sliding end position of the locating sliding track are determined.

A locating cursor on the locating control is slid from the locating sliding start position to the locating sliding end position to slide proportionally to the second data sliding track.

In the above solution, after each piece of position information corresponding to the information of the position to be located is taken as a position identifier to obtain the navigation point, the method may further include the following operation.

When the number of the navigation points is greater than a preset number, a preset number of navigation points are selected from the navigation points for display, and the unselected navigation points in the navigation points are hidden. The preset number is a set number of navigation points displayed on the locating control.

In the above solution, the method may further include the following operation.

When function applying is performed, the display interface is loaded through a locating device.

In a second aspect, the embodiments of the disclosure provide a locating device, which may include: a processor, a memory and a communication bus. The memory communicates with the processor through the communication bus. The memory stores a program that the processor can execute. When executed, the program performs through the processor the above locating method.

In a third aspect, the embodiments of the disclosure provide a computer-readable storage medium, which stores a program. When executed by the processor, the program implements the above locating method.

The embodiments of the disclosure provide a locating method and device, and a storage medium. First, the locating control provided with the navigation point is displayed at the first preset position on the display interface on which list data is loaded. The navigation point represents the identifier corresponding to the position marked in a loaded data link in the list data. Then, when the first locating operation acting on the navigation point is received, the corresponding position of first data to be located is determined in the loaded data link. Finally, jumping to the position of the first data to be located is performed on the display interface, and the first data to be located corresponding to the position of first data to be located is displayed to locate the first data to be located on the display interface. By using the above technical implementation solutions, because the locating control provided with the navigation point is added and displayed on the display interface where the list data is loaded, and because the navigation point is the identifier corresponding to the position marked in the loaded data link in the list data, and the position marked in the loaded data link is the position corresponding to the data of interest, the navigation point is the identifier of the position corresponding to the data of interest. Thus, the locating device can display the first data to be located (the data of interest) by responding to the locating operation acting on the navigation point, so as to quickly locate to the data of interest. The above is a solution for quickly locating the data of interest in the browsed list data (the loaded data link) on the display interface where the list data is loaded, and the solution for locating has low power consumption and low complexity.

### BRIEF DESCRIPTION OF THE DRAWINGS

FIG. 1 illustrates a flowchart implementing a locating method provided by an embodiment of the disclosure.

FIG. 2 illustrates an exemplary first preset position for displaying a locating control provided by an embodiment of the disclosure.

FIG. 3 illustrates a schematic diagram of an exemplary first locating operation provided by an embodiment of the disclosure.

FIG. 4 illustrates a schematic diagram of exemplarily obtaining marked position information provided by an embodiment of the disclosure.

FIG. 5 is a first exemplary flowchart illustrating a locating control provided by an embodiment of the disclosure.

FIG. 6 is a second exemplary flowchart illustrating a locating control provided by an embodiment of the disclosure.

FIG. 7 is a third exemplary flowchart illustrating a locating control provided by an embodiment of the disclosure.

FIG. 8 illustrates an exemplary display interface provided by an embodiment of the disclosure.

FIG. 9 illustrates a schematic diagram of an exemplary display prompt box provided by an embodiment of the disclosure.

FIG. 10 illustrates a first structure diagram of a locating device provided by an embodiment of the disclosure.

FIG. 11 illustrates a second structure diagram of a locating device provided by an embodiment of the disclosure.

### DETAILED DESCRIPTION

The technical solutions in the embodiments of the disclosure are clearly and completely described below in conjunction with the accompanying drawings in the embodiments of the disclosure.

### First Embodiment

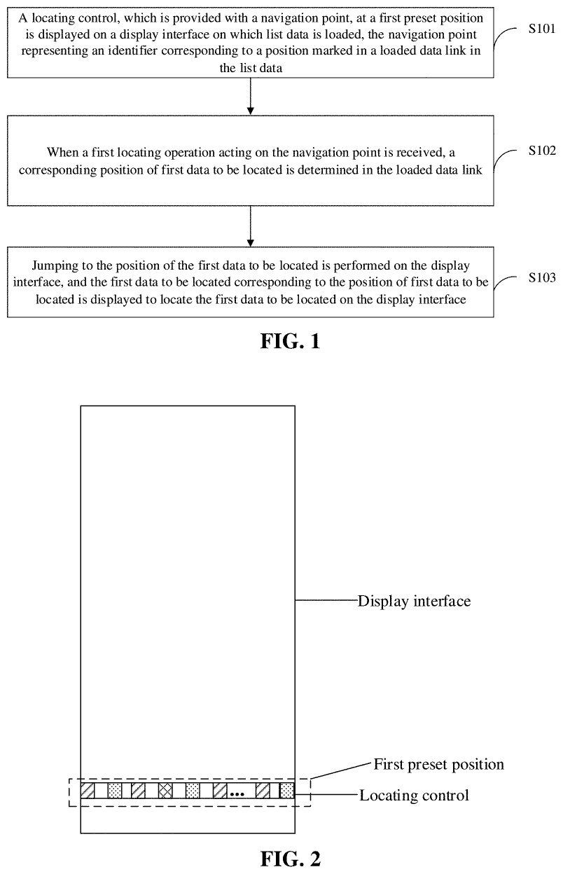

The embodiments of the disclosure provide a locating method. FIG. 1 illustrates a flowchart implementing a locating method provided by an embodiment of the disclosure. As illustrated in FIG. 1, the locating method includes the following operations.

At S101, a locating control, which is provided with a navigation point, at a first preset position is displayed on a display interface on which list data is loaded. The navigation point represents an identifier corresponding to a position marked in a loaded data link in the list data.

In the embodiments of the disclosure, when displaying the list data, a locating device loads the list data on the display interface, that is, on the display interface where the list data is loaded. In addition, the first preset position is preset on the display interface. The locating device draws a locating control corresponding to the loaded data link on the display interface in a preset corresponding proportion, and the locating control is provided with the navigation point. The locating device displays the locating control provided with the navigation point at the first preset position.

It is to be noted that the list data contains at least one datum, the locating device displays the at least one datum in the list data in the form of a list, and when there is more data in the list data, the display of the list data is achieved through multiple times of loading. The loaded data link is the data link formed by the loaded list data on the display interface, that is, the loaded list data is displayed on the display interface in the form of a link.

The preset corresponding proportion represents a relationship that the locating control corresponds to the loaded data link on the position in equal proportion, that is, each datum in the loaded data link has a corresponding position in the locating control. Specifically, when the locating control corresponds to a first length, the loaded data link corresponds to a second length, a first target point is set in the first length, and a second target point is set in the second length, the distance between a length field in the first length and the first target point corresponds to the distance between the length field in the second length and the second target point in equal proportion.

The first preset position may be any position on the display interface, such as the top, bottom, left or right of a display screen, which is not specifically limited in the embodiments of the disclosure. For example, FIG. 2 illustrates an exemplary first preset position for displaying the locating control provided by an embodiment of the disclosure. As illustrated in FIG. 2, the first preset position is the lower end of the display interface, and the locating control is displayed at the lower end of the display interface.

The navigation point represents the identifier corresponding to the position marked in the loaded data link in the list data, that is, the navigation point corresponds to the marked data in the list data, which is usually the data that a user is interested in; in addition, the marked data may be determined through a marking operation, preset in the list data, or obtained according to a preset rule, which is not specifically limited in the embodiments of the disclosure. In addition, the identifier corresponding to the position marked in the loaded data link is mark information for display in the locating control.

The locating control represents a control for locating the data in the loaded data link, and the locating control may be presented either horizontally or vertically, etc., which is not specifically limited in the embodiments of the disclosure. In addition, as a navigation bar of the loaded data link on the display interface, the locating control can be fully presented on the display screen. The data in the loaded data link is data which has been browsed by the user.

It should also be noted that the number of the navigation points is consistent with the number of the positions marked in the loaded data link, each being at least one. The locating control may hover over the display interface in a transparent mode, a translucent mode, or other display modes, which is not specifically limited in the embodiments of the disclosure.

It is understandable that by displaying the locating control corresponding to a loaded data record on the display interface displaying the loaded data link, and setting on the locating control the navigation point that represents the identifier corresponding to the position marked in the loaded data link, because the data corresponding to the position marked in the loaded data link is usually the data of interest, the locating device can quickly locate the data of interest on the display interface, thus improving a displaying effect and locating effect of the list data.

At S102, when a first locating operation acting on the navigation point is received, a corresponding position of first data to be located is determined in the loaded data link.

In the embodiments of the disclosure, because the navigation point represents the identifier corresponding to the position marked in the loaded data link, and the data corresponding to the position marked in the loaded data link is usually the data of interest, the locating device can determine the position of the data of interest in the loaded data link by operating the navigation point on the locating control, so as to implement the locating of the data of interest.

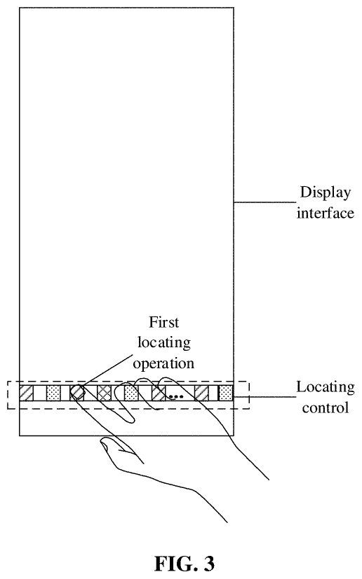

Specifically, when locating the data of interest in the loaded data link through the locating control, the locating device can receive the first locating operation acting on the navigation point on the locating control, at this point, the locating device determines the position of the navigation point on which the first locating operation acts in the loaded data link, that is, the position of the first data to be located, according to the preset corresponding proportion. The position of the first data to be located represents a distance between the corresponding data in the loaded data link and the target point, which is an identification point or position set in the loaded data link. Here, the first locating operation is used for quickly locating the marked data in the loaded data record. For example, the first locating operation is a click operation on the navigation point, as shown in FIG. 3. For another example, the first locating operation is a double-click operation on the navigation point. In addition, in the embodiments of the disclosure, the first locating operation may also be other operations for triggering the obtaining of the corresponding position of the navigation point on the locating control marked in the loaded data link.

At S103, jumping to the position of the first data to be located is performed on the display interface, and the first data to be located corresponding to the position of first data to be located is displayed to locate the first data to be located on the display interface.

In the embodiments of the disclosure, after obtaining the position of the first data to be located, the locating device jumps to the position of the first data to be located on the display interface; at this point, the display screen shows the first data to be located corresponding to the position of the first data to be located, and the locating of the first data to be located on the loaded data link is completed.

It is to be noted that the first data to be located is one of the marked data in the loaded data link. When the marked data in the loaded data link is the data that the user is interested in, the first data to be located is one of the data that the user is interested in.

It is understandable that by drawing the locating control corresponding to the loaded data link in equal proportion and displaying the position marked in the loaded data link as the navigation point in the locating control, and displaying the locating control on the display interface, the locating device implements the accurate and quick locating of the data of interest in the loaded data link through the first locating operation acting on the navigation point of the locating control. Even when there is more data in the loaded data link, the locating device can still implement the accurate and quick locating of the marked data in the loaded data link. In addition, the locating is implemented in the display interface where the list data is loaded, so the locating effect is good.

Furthermore, in the embodiments of the disclosure, the navigation point is provided in the locating control, so before the locating device displays the locating control, which is provided with the navigation point, at the first preset position on the display interface on which the list data is loaded at S101, there is also a process of obtaining the navigation point, which specifically includes S104 to S105.

At S104, information of a position to be located is obtained. The information of the position to be located represents a distance between data marked in the loaded data link and a target point.

In the embodiments of the disclosure, there is marked data in the loaded data link, and the corresponding position of the marked data in the loaded data link is the information of the position to be located. When there is the preset corresponding proportion between the loaded data link and the locating control, the information of the position to be located represents the distances between the marked data in the loaded data link and the target points. Here, the target points are the top, bottom, or other identification points in the loaded data link.

It is to be noted that the relationship between the position of the first data to be located and the information of the position to be located is that the position of the first data to be located is one of the information of the position to be located.

At S105, each piece of position information corresponding to the information of the position to be located is taken as a position identifier to obtain the navigation point.

In the embodiments of the disclosure, after the locating device obtains the information of the position to be located, because the information of the position to be located contains at least one piece of position information, when converting the information of the position to be located into the navigation point in the locating control, the locating device takes each piece of position information corresponding to the information of the position to be located as a position identifier, and all or at least one of the position identifiers forms the navigation point.

Specifically, when converting the information of the position to be located into the navigation point in the locating control, the locating device first determines the position information of at least one position identifier in the locating control according to the preset corresponding proportion. Then, the locating device displays the determined position information of at least one position identifier in the locating control on the display interface to complete the conversion and display of the information of the position to be located to the navigation point on the locating control.

Furthermore, in the embodiments of the disclosure, the information of the position to be located includes at least one of marked position information, position information of a list data group or recommended position information.

It is to be noted that the marked position information represents the position information obtained by marking the data in the loaded data link by the locating device. The position information of a list data group represents the position information corresponding to each group divided according to a preset loading rule when the list data is loaded. The recommended position information represents recommended position information obtained by analyzing a historical mark position of the list data.

Furthermore, in the embodiments of the disclosure, when the information of the position to be located is the marked position information, before the locating device obtains the information of the position to be located at S104, the locating method further includes S106.

At S106, a marking control is displayed at the corresponding position of each datum in the loaded data link on the display interface.

In the embodiments of the disclosure, the locating device displays the marking control used for obtaining the marked position information at the corresponding position of each datum corresponding to the loaded data link on the display interface, and determines through the marking control whether the corresponding position of the data is the marked position information.

Here, the marking control is an additional control used for obtaining the information of the position to be located in the embodiments of the disclosure. The amount of data in the loaded data link is consistent with the number of the marking controls.

Correspondingly, S104, at which the locating device obtains the information of the position to be located, specifically includes S104a1 to S104a3.

At S104a1, when a triggering operation acting on at least one of the marking controls is received, at least one corresponding marked datum is obtained according to at least one of the triggering operations.

In the embodiments of the disclosure, after setting the marking control, the locating device monitors operations on the marking control. When the triggering operation is detected, that is, the triggering operation acting on at least one of the marking controls is received, the locating device obtains at least one corresponding marked datum according to the at least one triggering operation. Here, the marked data refers to the data that the marking control in the loaded data link receives the triggering operation.

At S104a2, the distance between the at least one marked datum and the target point is taken as the marked position information.

In the embodiments of the disclosure, after obtaining at least one marked datum, the locating device obtains the corresponding position of the at least one marked datum in the loaded data link. When there is the preset corresponding proportion between the loaded data link and the locating control, the locating device obtains the distances between the at least one marked datum and the target points. Here, the distance between the at least one marked datum and the target point is taken as the marked position information.

At S104a3, the marked position information is taken as the information of the position to be located.

Here, after the locating device obtains the marked position information, because the marked position information is the information of the position to be located, the locating device obtains the information of the position to be located.

FIG. 4 illustrates a schematic diagram of exemplarily obtaining the marked position information provided by an embodiment of the disclosure. As illustrated in FIG. 4, the marking control is set for each datum of the loaded data link on the display interface. On the display interface, the corresponding marked position information, for example, the form of displaying the marking control corresponding to the marked data 6, is obtained by clicking the marking control (the triggering operation). The obtaining of the marked position information may also be canceled by clicking the marking control.

It is understandable that by setting the marking control, when browsing the loaded data link, the user can quickly locate, through the navigation point in the locating control, the marked data of interest by marking some data of interest and converting the corresponding position of the data of interest into the navigation point and adding the navigation point to the locating control.

Furthermore, in the embodiments of the disclosure, when the information of the position to be located is the position information of a list data group, before the locating device obtains the information of the position to be located at S104, the locating method further includes S107.

At S107, the list data is divided into at least one group of data according to the preset loading rule.

In the embodiments of the disclosure, the locating device can divide the list data into at least one group of data based on the preset loading rule. When the list data is loaded, only one group of data is loaded each time, and the display of the list data is realized through multiple times of loading.

It is to be noted that the preset loading rule may be that the list data is grouped by the amount of data that is loaded per page, by the amount of data that can be displayed on the display screen, or by corresponding categories, which is not specifically limited in the embodiments of the disclosure.

Correspondingly, S104, at which the locating device obtains the information of the position to be located, specifically includes S104b1 to S104b3.

At S104b1, identification data of each group of data in the loaded data link is obtained.

In the embodiments of the disclosure, after the list data is grouped, the locating device takes representative data representing each group of data in the grouped list data as the identification data, that is, it obtains the identification data of each group of data in the loaded data link.

At S104b2, the distance between at least one identification datum and the target point is taken as the position information of a list data group.

In the embodiments of the disclosure, after obtaining at least one identification datum, the locating device takes the position of the at least one identification datum in the loaded data link as the position of the corresponding data group in the loaded data link, and obtains the corresponding position of the at least one identification datum in the loaded data link. When there is the preset corresponding proportion between the loaded data link and the locating control, the locating device obtains the distances between the at least one identification datum and the target points. Here, the distance between the at least one identification datum and the target point is taken as the position information of a list data group.

At S104b3, the position information of a list data group is taken as the information of the position to be located.

Here, after the locating device obtains the position information of a list data group, because the position information of a list data group is the information of the position to be located, the locating device obtains the information of the position to be located.

It is understandable that because the information of the position to be located represents the position of each group of data when the list data is loaded, each group of data can be quickly located through the navigation point of the locating control.

Furthermore, in the embodiments of the disclosure, when the information of the position to be located is the recommended position information, S104, at which the locating device obtains the information of the position to be located, specifically includes S104c1 to S104c5.

At S104c1, when a data loading request for the list data is received, feature information of the corresponding data requester is obtained.

In the embodiments of the disclosure, when receiving the data loading request for the list data, the locating device responds to the data loading request and obtains the feature information of the corresponding data requester. Here, the feature information of the data requester represents attribute information of the data requester.

At S104c2, the feature information of the data requester is input into a preset marking model to obtain list recommending position information corresponding to the list data. The preset marking model is used for determining a position information of a recommended mark in the list data.

In the embodiments of the disclosure, after obtaining the feature information of the data requester, the locating device can obtain list recommending position information corresponding to the list data by inputting the feature information of the data requester into a preset marking model which is used for determining a position information of a recommended mark in the list data according to the feature information of the data requester.

At S101c3, corresponding recommended data is obtained from the list recommending position information according to the loaded data link on the display interface.

In the embodiments of the disclosure, after the locating device obtains the list recommending position information corresponding to the list data, because only the loaded data link is displayed on the display interface, the locating device needs to obtain the recommended data corresponding to the loaded data link on the display interface from the list recommending position information, that is, the recommended data represents the data corresponding to the list recommending position information in the loaded data link.

At S101c4, the distance between the recommended data and the target point is taken as the recommended position information.

In the embodiments of the disclosure, after obtaining the recommended data, the locating device obtains the position of the recommended data in the loaded data link. When there is the preset corresponding proportion between the loaded data link and the locating control, the locating device obtains the distance between the recommended data and the target point, and takes the distance between the recommended data and the target point as the recommended position information.

It is to be noted that when there is at least one of recommended data, correspondingly, there is at least one piece of recommended position information.

At S101c5, the recommended position information is taken as the information of the position to be located.

Here, after the locating device obtains the position information of a list data group, because the recommended position information is the information of the position to be located, the locating device obtains the information of the position to be located.

Furthermore, in the embodiments of the disclosure, before S104c2, the locating method further includes a process of training the preset marking model, which specifically includes: first, the locating device obtains historical marking information corresponding to the list data, the historical marking information representing information associated with a historical marking operation acting on the marking control and corresponding to the list data; then, the locating device obtains, according to the historical marking information, the corresponding historical marked position information and the feature information of a marking participant; finally, the locating device trains the model according to the historical marked position information and the feature information of the marking participant to obtain the preset marking model.

Exemplarily, when the list data is a list of items, the corresponding historical marked position information and the feature information of the marking participant is obtained according to the previous marked position (the historical marking information) of the user, with a big data artificial intelligence analysis technology, the feature information of the marking participant is classified and processed by using a nearest neighbor algorithm to finally obtain classification results of the marking participant, and the feature information of the marking participant and the corresponding marked position information in each classification result is determined, thus obtaining the preset marking model.

It is understandable that by determining the preset marking model which represents a corresponding relationship between the historical marking information and the feature information of the marking participant according to the historical marking information corresponding to the list data, the locating device determines the position information that the data requester may be interested in according to the preset marking model, thus implementing a solution of recommending positions based on users' preferences.

In addition, because the information of the position to be located includes at least one of the marked position information, the position information of a list data group or the recommended position information, indicating that the information of the position to be located has different types, the forms of displaying the navigation point corresponding to the information of the position to be located in the locating control on the display interface are different. For example, when the information of the position to be located is the marked position information, the form of displaying the navigation point corresponding to the information of the position to be located in the locating control is an first identification point; when the information of the position to be located is the position information of a list data group, the form of displaying the navigation point corresponding to the information of the position to be located in the locating control is an second identification point; and when the information of the position to be located is the recommended position information, the form of displaying the navigation point corresponding to the information of the position to be located in the locating control is an third identification point.

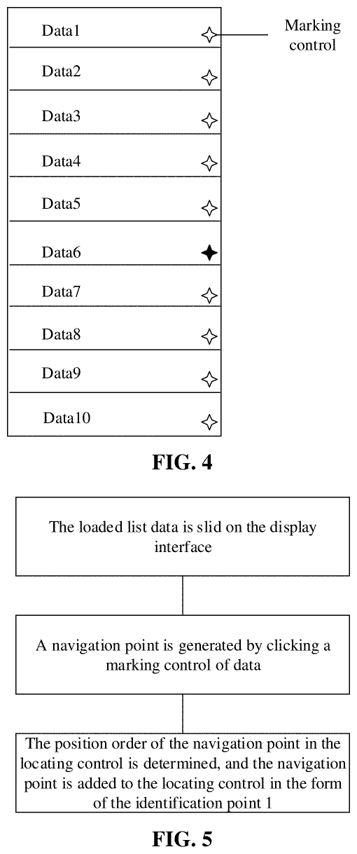

Exemplarily, FIG. 5 is a first exemplary flowchart illustrating the locating control provided by an embodiment of the disclosure. As illustrated in FIG. 5, a process of drawing the locating control when the information of the position to be located is the marked position information is described. The loaded list data is slid on the display interface. A marking control of data is clicked, and a navigation point is generated. The position order of the navigation point in the locating control is determined (which may be obtained by sorting all the navigation points in the locating control), and the navigation point is added to the locating control in the form of the first identification point. The process is repeated until the list data is loaded.

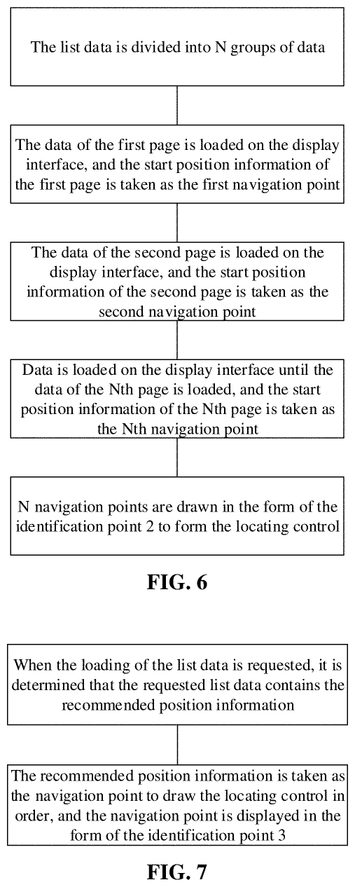

FIG. 6 is a second exemplary flowchart illustrating the locating control provided by an embodiment of the disclosure. As illustrated in FIG. 6, a process of drawing the locating control when the information of the position to be located is the position information of a list data group is described. The locating device divides the list data into N groups of data (at least one group of data), and achieves the display of the list data through multiple times of loading. On the display interface, the display interface is slid to load the list data. The display interface loads a data record of the first page, and takes the position corresponding to the first data of the data record of the first page as the first navigation point; the display interface loads a data record of the second page, and takes the position corresponding to the first data of the data record of the second page as the second navigation point, and so on, until the display interface loads a data record of the Nth page, and takes the position corresponding to the first data of the data record of the Nth page as the Nth navigation point. At this point, the locating device has obtained N navigation points, and draws the locating control composed of N navigation points in the form of the second identification point.

FIG. 7 is a third exemplary flowchart illustrating the locating control provided by an embodiment of the disclosure. As illustrated in FIG. 7, a process of drawing the locating control when the information of the position to be located is the recommended position information is described. When the loading of the list data is requested, it is determined that the requested list data contains the recommended position information, the recommended position information is taken as the navigation point to draw the locating control in order, and the navigation point is displayed in the form of the third identification point.

Furthermore, in the embodiments of the disclosure, except the data can be located through the navigation point, other data locating modes can also be included. For example, the data can be located through the identification points between the navigation points, or through a sliding track on the locating control; that is, after the locating device displays the locating control, which is provided with the navigation point, at the first preset position on the display interface on which the list data is loaded at S101, the locating method further includes S108 to S109.

At S108, when a second locating operation acting on a non-navigational point of the locating control is received, a corresponding position of second data to be located is determined in the loaded data link. The non-navigational point represents information on a position on the locating control other than a navigation point.

In the embodiments of the disclosure, because the locating control corresponds to the loaded data link, any locating operation acting on the location control can achieve the locating of data in the loaded data link. Here, the locating device takes the information other than a navigation point position that the locating control contains as a non-navigation point, that is, the non-navigation point includes the identification points between the navigation points and the sliding track on the locating control. At this point, the locating device can receive a second locating operation acting on the the non-navigation point on the locating control, and determine the position of the non-navigation point on which the second locating operation acts in the loaded data link, that is, a position of second data to be located, according to the preset corresponding proportion. The position of the second data to be located represents a distance between a corresponding data set in the loaded data link and the target point, and the target point is an identification point or position set in the loaded data link.

It is to be noted that the second locating operation represents a triggering operation for the identification points between the navigation points, or a triggering operation for multiple consecutive identification points on the locating control.

At S109, jumping to the position of the second data to be located is performed on the display interface, and the second data to be located corresponding to the position of second data to be located is displayed to locate the second data to be located on the display interface.

In the embodiments of the disclosure, when obtaining the position of the second data to be located, that is, determining the position to be located in the loaded data link, the locating device jumps to the position of the second data to be located on the display interface, and shows the second data to be located corresponding to the position of the second data to be located, and then the locating on the loaded data link is implemented.

Exemplarily, when the second locating operation is triggering the identification point between two navigation points, the locating device can determine, according to the preset corresponding proportion between the locating control and the loaded data link, the corresponding position of the identification point between the two navigation points in the loaded data link, jumps to the corresponding position of the identification point between the two navigation points in the loaded data link, and displays the corresponding data, so as to complete the locating of data corresponding to the triggering operation on the non-navigational point.

In addition, when the second locating operation is triggering multiple consecutive identification points on the locating control, the second locating operation is a first sliding operation, that is, the first sliding operation represents the sliding operation received by the locating control.

Furthermore, when the second locating operation at S108 is the first sliding operation, S108, at which when the second locating operation acting on the non-navigational point of the locating control is received, the corresponding position of the second data to be located is determined in the loaded data link, specifically includes that: when the first sliding operation acting on the non-navigational point of the locating control is received, the locating device determines a corresponding first data sliding track, which is the position of the second data to be located, in the loaded data link.

That is, the first data sliding track represents the sliding track of multiple consecutive identification points on the locating control in the loaded data link. Specifically, the locating device can determine the sliding track of multiple consecutive identification points on the locating control in the loaded data link, that is, the first data sliding track, according to the preset corresponding proportion between the locating control and the loaded data link.

Correspondingly, S109, at which the locating device jumps to the position of the second data to be located on the display interface, and displays the second data to be located corresponding to the position of second data to be located to locate the second data to be located on the display interface, specifically includes that: the locating device determines a data sliding start position and a data sliding end position of the first data sliding track, jumps to the data sliding start position on the display interface, slides the data until the data reaches the data sliding end position, and displays the second data to be located corresponding to the first data sliding track to locate the second data to be located on the display interface. Here, the data sliding start position represents the start position at which the data in the loaded data link is slid, and the data sliding end position represents the end position at which the data in the loaded data link is slid.

That is, the locating device can implement that the data in the loaded data link can be slid in equal proportion according to the sliding track on the locating control. In this way, when the list data is loaded by pages in the form of long list, the sliding of the located data is the sliding of data in the long list on the display interface. When the loading of the list data is displayed by pages, the sliding of the located data is displayed by turning pages on the display interface, that is, the locating control can locate paging data on the previous or next page of the loaded data record.

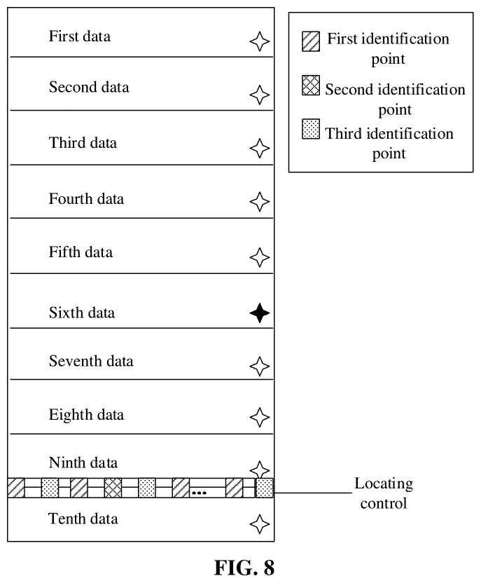

Exemplarily, FIG. 8 illustrates an exemplary display interface provided by an embodiment of the disclosure. As illustrated in FIG. 8, the display interface can display 10 data through the display screen at a time. The current display screen displays the data corresponding to the first navigation point from the left in the locating control. The locating control is a horizontal navigation bar and displayed at the bottom (the first preset position) of the display interface in a transparent mode. The navigation bar contains the navigation points of three types (a first identification point, a second identification point and a third identification point), representing the corresponding different information of the position to be located. Specifically, the first identification point represents the marked data, the second identification point represents the start position of each group of loaded data, and the third identification point represents the data recommended marking.

Furthermore, in the embodiments of the disclosure, after the locating device displays the locating control, which is provided with the navigation point, at the first preset position on the display interface on which the list data is loaded at S101, the locating method further includes S110 to S111.

At S110, a display operation acting on the navigation point is received.

In the embodiments of the disclosure, after the locating device completes the drawing of the locating control, because the navigation point corresponding to the information of the position to be located is displayed on the locating control, the locating device can monitor the operation of the navigation point on the locating control to determine whether the display operation acting on the navigation point on the locating control is received.

At S111, according to the display operation, a prompt box is displayed at a second preset position on the display interface. The second preset position represents a position corresponding to the navigation point on the display interface, and the prompt box represents information of the loaded data link corresponding to the navigation point.

In the embodiments of the disclosure, when receiving the display operation acting on the navigation point on the locating control, the locating device displays, according to the display operation, the information prompt box representing the loaded data link corresponding to the navigation point at a position representing the position corresponding to the navigation point on the display interface.

It is to be noted that the second preset position may also be the upper part of the navigation point on the display interface, or other nearby positions of the navigation point on the display interface, etc., which is not specifically limited in the embodiments of the disclosure. In addition, the prompt box may be displayed on the display interface in the form of a floating box. Specifically, the prompt box may be in translucent, opaque state and completely transparent states. The embodiments of the disclosure do not specify the display form and state of the prompt box.

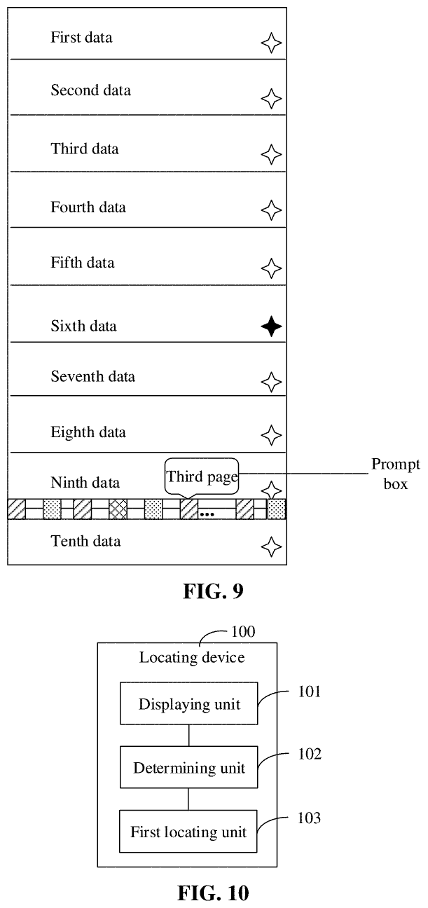

Exemplarily, FIG. 9 illustrates a schematic diagram of an exemplary display prompt box provided by an embodiment of the disclosure. When the first navigation point from the left illustrated in FIG. 9 is pressed and held (the display operation), as illustrated in FIG. 9, the prompt box corresponding to the first navigation point from the left is displayed.

It is understandable that the locating device can assist in the quick locating of the data in the loaded data link by displaying the prompt box for the navigation point on the locating control.

Furthermore, in the embodiments of the disclosure, after the locating device displays the locating control, which is provided with the navigation point, at the first preset position on the display interface on which the list data is loaded at S101, the locating method further includes S112 to S115.

At S112, a second data sliding track of the loaded data link on the display interface is obtained.

In the embodiments of the disclosure, when sliding the data in the loaded data link on the display interface, the locating device obtains the second data sliding track of the loaded data link on the display interface. The second data sliding track represents the corresponding track when the data of the loaded data link on the display interface is slid.

At S113, a locating sliding track is determined on the locating control according to the second data sliding track.

In the embodiments of the disclosure, because there is the preset corresponding proportion between the loaded data link and the locating control, the locating device can determine the locating sliding track corresponding to the second data sliding track in the locating control.

At S114, a locating sliding start position and a locating sliding end position of the locating sliding track are determined.

In the embodiments of the disclosure, after obtaining the locating sliding track, the locating device determines the locating sliding start position and the locating sliding end position. Here, the locating sliding start position represents the start position at which the locating control is slid, and the locating sliding end position represents the end position at which the locating control is slid.

At S115, a locating cursor on the locating control is slid from the locating sliding start position to the locating sliding end position to slide proportionally to the second data sliding track.

In the embodiments of the disclosure, after obtaining the locating sliding start position and the locating sliding end position corresponding to the locating sliding track, the locating device can achieve, on the locating control of the display interface, an effect that the information of the locating control slides along with the sliding of the data in the loaded data link. Specifically, there is a locating cursor set in the locating device. The locating cursor represents a display focus on the locating control. The locating device slides the locating cursor on the locating control from the locating sliding start position to the locating sliding end position to implement the sliding of equal proportion corresponding to the second data sliding track.

It is to be noted that because the loaded data link on the display interface corresponds to the locating control on position in equal proportion, when sliding the data in the loaded data link on the display interface, the locating control will slide correspondingly. When the locating control slides, the data in the loaded data link will be slid on the display interface. In addition, the embodiments of the disclosure do not specify the direction of the sliding.

Furthermore, in the embodiments of the disclosure, after the locating device takes each piece of position information corresponding to the information of the position to be located as a position identifier to obtain the navigation point at S104, the locating method further includes S116.

At S116, when the number of the navigation points is greater than a preset number, a preset number of navigation points are selected from the navigation points for display, and the unselected navigation points in the navigation points are hidden. The preset number is the number of the navigation points provided on the locating control.

In the embodiments of the disclosure, when the amount of the position information represented by the information of the position to be located is greater than a preset amount, the information representing the information of the position to be located in the locating control is presented in a sliding way, as shown by the locating control in FIG. 8 to FIG. 9.

Here, the locating device hides the unselected navigation points in the navigation points through a hidden marker in a hidden area. The hidden area specifies a preset area between two navigation points on the locating control. The hidden marker is an ellipsis. When the ellipsis is clicked, the unselected navigation points are presented. For example, the locating device displays the unselected navigation points in the middle of the locating control by displaying the selected navigation points at the head and tail of the locating control. Or, the locating device displays the selected navigation points at intervals.

It is to be noted that a maximum of a preset number of navigation points can be set in the locating control. When the amount of the position information represented by the information of the position to be located is greater than the preset amount, it indicates that all the navigation points corresponding to the information of the position to be located cannot be displayed in the locating control; in this case, the navigation point in the drawn locating control is presented in the sliding way, that is, the information representing the information of the position to be located in the locating control is presented in the sliding way.

Furthermore, in the embodiments of the disclosure, when function applying is performed, the display interface is loaded through the locating device. That is, the locating device may be used as an independent list component, and when function applying is performed, the locating method in the embodiments of the disclosure is implemented through the locating device. The list component includes a locating control. In the specific application, in order to complete the quick locating of the loaded data link in the list data by using the list component provided by the embodiments of the disclosure, the developer only needs to provide a list data loading function and the layout of each datum. For example, when the function application is the display of item data, the quick locating of the loaded item data can be implemented by calling the locating device in the embodiments of the disclosure. For another example, when the function application is the display of a file, the quick locating of the loaded file can be implemented by calling the locating device in the embodiments of the disclosure.

In the embodiments of the disclosure, the mentioned position in the locating device represents the distance between the identification point and the target point set in the locating device, and the position in the loaded data link represents the distance between the data or data set and the target point in the loaded data link.

It is understandable that because the locating control provided with the navigation point is added and displayed on the display interface where the list data is loaded, and because the navigation point is the identifier corresponding to the position marked in the loaded data link in the list data, and the position marked in the loaded data link is the position corresponding to the data of interest, the navigation point is the identifier of the position corresponding to the data of interest. Thus, the locating device can display the first data to be located (the data of interest) by responding to the locating operation acting on the navigation point, so as to quickly locate to the data of interest. The above is a solution for quickly locating the data of interest in the browsed list data (the loaded data link) on the display interface where the list data is loaded, and the solution for locating has low power consumption and low complexity.

### Second Embodiment

Based on the same inventive concept in the first embodiment, the embodiments of the disclosure provide a locating device 100. FIG. 10 illustrates a first structure diagram of a locating device provided by an embodiment of the disclosure. As illustrated in FIG. 10, the locating device 100 includes: a displaying unit 101, a determining unit 102, and a first locating unit 103.

The displaying unit 101 is configured to display the locating control, which is provided with the navigation point, at the first preset position on the display interface on which the list data is loaded. The navigation point represents the identifier corresponding to the position marked in the loaded data link in the list data.

The determining unit 102 is configured to determine, when the first locating operation acting on the navigation point is received, the corresponding position of the first data to be located in the loaded data link.

The first locating unit 103 is configured to jump to the position of the first data to be located on the display interface, and display the first data to be located corresponding to the position of first data to be located to locate the first data to be located on the display interface.

Furthermore, the locating device 100 further includes an obtaining unit 104, configured to obtain the information of the position to be located which represents the distance between the data marked in the loaded data link and the target point, and take each piece of position information corresponding to the information of the position to be located as the position identifier to obtain the navigation point.

Furthermore, the information of the position to be located includes at least one of the marked position information, the position information of a list data group or the recommended position information.

Furthermore, when the information of the position to be located is the marked position information, the locating device 100 further includes a setting unit 150, configured to display the marking control at the corresponding position of each datum in the loaded data link on the display interface.

Correspondingly, the first obtaining unit 104 is specifically configured to obtain, when the triggering operation acting on at least one of the marking controls is received, at least one corresponding marked datum according to at least one of the triggering operations, take the distance between the at least one marked datum and the target point as the marked position information, and take the marked position information as the information of the position to be located.

Furthermore, when the information of the position to be located is the position information of a list data group, the locating device 100 further includes a grouping unit 106, configured to divide the list data into at least one group of data according to the preset loading rule.

Correspondingly, the first obtaining unit 104 is specifically configured to obtain the identification data of each group of data in the loaded data link, take the distance between the at least one of the identification data and the target point as the position information of a list data group, and take the position information of a list data group as the information of the position to be located.

Furthermore, when the information of the position to be located is the recommended position information, the first obtaining unit 104 is specifically configured to obtain, when the data loading request for the list data is received, the feature information of the corresponding data requester, and input the feature information of the data requester into the preset marking model to obtain the list recommending position information corresponding to the list data. The preset marking model is configured to determine a position information of a recommended mark in the list data, obtain the corresponding recommended data from the list recommending position information according to the loaded data link on the display interface, take the distance between the recommended data and the target point as the recommended position information, and take the recommended position information as the information of the position to be located.

Furthermore, the first obtaining unit 104 is specifically configured to obtain the historical marking information corresponding to the list data, the historical marking information representing the information associated with the historical marking operation acting on the marking control and corresponding to the list data, obtain the corresponding historical marked position information and the feature information of the marking participant according to the historical marking information, and train the model according to the historical marked position information and the feature information of the marking participant to obtain the preset marking model.

Furthermore, the locating device 100 further includes a second locating unit 107, configured to determine, when the second locating operation acting on the non-navigational point of the locating control is received, the corresponding position of the second data to be located in the loaded data link, the non-navigational point representing the information other than a navigation point position that the locating control contains, jump to the position of the second data to be located on the display interface, and display the second data to be located corresponding to the position of second data to be located to locate the second data to be located on the display interface.

Furthermore, when the second locating operation is the first sliding operation, the second locating unit 107 is specifically configured to determine, when the first sliding operation acting on the non-navigational point of the locating control is received, the corresponding first data sliding track in the loaded data link, the first data sliding track being the position of the second data to be located, determine the data sliding start position and the data sliding end position of the first data sliding track, jump to the data sliding start position on the display interface and slide the data until the data reaches the data sliding end position, and display the second data to be located corresponding to the first data sliding track to locate the second data to be located on the display interface.

Furthermore, the locating device 100 further includes a prompting unit 108, configured to receive the display operation acting on the navigation point, and display the prompt box at the second preset position on the display interface according to the display operation. The second preset position represents a position corresponding to the navigation point on the display interface, and the prompt box represents information of the loaded data link corresponding to the navigation point.

Furthermore, the locating device 100 further includes a sliding unit 109, configured to obtain the second data sliding track of the loaded data link on the display interface, determine the locating sliding track on the locating control according to the second data sliding track, determine the locating sliding start position and the locating sliding end position of the locating sliding track, and slide the locating cursor on the locating control from the locating sliding start position to the locating sliding end position to slide proportionally to the second data sliding track.

Furthermore, the locating device 100 further includes a selecting unit 110, configured to select, when the number of the navigation points is greater than the preset number, a preset number of navigation points from the navigation points for display, and hide the unselected navigation points in the navigation points. The preset number is the number of the navigation points provided on the locating control.

Furthermore, the locating device 100 further includes a loading unit 111, configured to load the display interface through the locating device when the function application is performed.

It is to be noted that in practical applications, the displaying unit 101, the determining unit 102, the first locating unit 103, the obtaining unit 104, the setting unit 105, the grouping unit 106, the second locating unit 107, the prompting unit 108, the sliding unit 109, the selecting unit 110 and the loading unit 111 may be realized a processor 112 in the locating device 100, specifically a Central Processing Unit (CPU), a Microprocessor Unit (MPU), a Digital Signal Processor (DSP) or a Field Programmable Gate Array (FPGA).

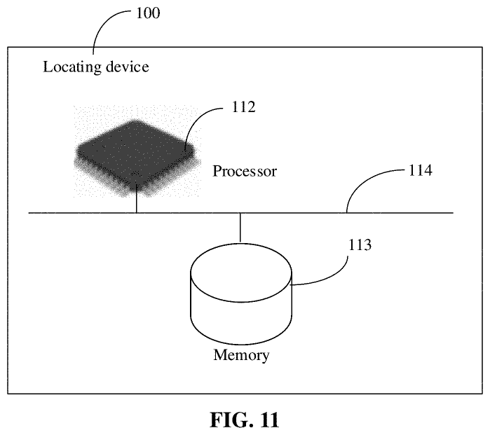

The embodiments of the disclosure also provide a locating device 100. As illustrated in FIG. 11, the locating device 100 includes: a processor 112, a memory 113 and a communication bus 114. The memory 113 communicates with the processor 112 through the communication bus 114. The memory 113 stores a program that the processor 112 can execute. When executed, the program performs the locating method in the first embodiment through the processor 112.

In practical applications, the memory 113 may be volatile memories, such as a Random-Access Memory (RAM), or non-volatile memories, such as a Read-Only Memory (ROM), a flash memory, a Hard Disk Drive (HDD) or a Solid-State Drive (SSD), or a combination of the above memories, and provides instructions and data to the processor 112.

The embodiments of the disclosure provide a computer-readable storage medium, which stores a program. When executed by the processor 112, the program implements the locating method in the first embodiment.

It is understandable that because the locating control provided with the navigation point is added and displayed on the display interface where the list data is loaded, and because the navigation point is the identifier corresponding to the position marked in the loaded data link in the list data, and the position marked in the loaded data link is the position corresponding to the data of interest, the navigation point is the identifier of the position corresponding to the data of interest. Thus, the locating device can display the first data to be located (the data of interest) by responding to the locating operation acting on the navigation point, so as to quickly locate to the data of interest. The above is a solution for quickly locating the data of interest in the browsed list data (the loaded data link) on the display interface where the list data is loaded, and the solution for locating has low power consumption and low complexity.

Those skilled in the art should understand that the embodiments of the disclosure may be provided as a method, a system, or a computer program product. So, the disclosure may adopt the forms of a hardware embodiment, a software embodiment, or an embodiment combining software and hardware. Moreover, the disclosure may adopt the form of a computer program product which is implemented on one or more computer available storage media (including, not limited to, a magnetic disk memory or an optical memory) including computer available program codes.

The disclosure is described according to the flowcharts and/or block diagrams of the method, the device (system) and the computer program product in the embodiments of the disclosure. It should be understood that each flow and/or block in the flowchart and/or block diagram, and the combination of the flow and/or block in the flowchart and/or block diagram can be implemented by the computer program instructions. These computer program instructions can be provided to a processor of a general-purpose computer, a special-purpose computer, an embedded processor or other programmable data processing devices to generate a machine, so that instructions which are executed by the processor of the computer or other programmable data processing devices generate a device which is used for implementing the specified functions in one or more flows of the flowchart and/or one or more blocks of the block diagram.

These computer program instructions may also be stored in the computer-readable memory which can guide the computer or other programmable data processing devices to work in a particular way, so that the instructions stored in the computer-readable memory generate a product including an instruction device. The instruction device implements the specified functions in one or more flows of the flowchart and/or one or more blocks of the block diagram.

These computer program instructions may also be loaded on the computer or other programmable data processing devices, so that a series of operation steps are performed on the computer or other programmable data processing devices to generate the processing implemented by the computer, and the instructions executed on the computer or other programmable data processing devices provide the steps for implementing the specified functions in one or more flows of the flowchart and/or one or more blocks of the block diagram.

The above is only the preferred embodiments of the disclosure and not intended to limit the protection scope of the disclosure.

### INDUSTRIAL APPLICABILITY

In the embodiments of the disclosure, because the locating control provided with the navigation point is added and displayed on the display interface where the list data is loaded, and because the navigation point is the identifier corresponding to the position marked in the loaded data link in the list data, and the position marked in the loaded data link is the position corresponding to the data of interest, the navigation point is the identifier of the position corresponding to the data of interest. Thus, the locating device can display the first data to be located (the data of interest) by responding to the locating operation acting on the navigation point, so as to quickly locate to the data of interest. The above is a solution for quickly locating the data of interest in the browsed list data (the loaded data link) on the display interface where the list data is loaded, and the solution for locating has low power consumption and low complexity.

1. A locating method applied to a locating device, comprising:
displaying a locating control, which is provided with a navigation point, at a first preset position on a display interface on which list data is loaded, wherein the navigation point represents an identifier corresponding to a position marked in a loaded data link in the list data;
when a first locating operation acting on the navigation point is received, determining a corresponding position of first data to be located in the loaded data link; and
jumping to the position of the first data to be located on the display interface, and displaying the first data to be located corresponding to the position of the first data to be located to locate the first data to be located on the display interface.

2. The method of claim 1, wherein before displaying the locating control, which is provided with the navigation point, at the first preset position on the display interface on which the list data is loaded, the method further comprises:
obtaining information of a position to be located, wherein the information of the position to be located represents a distance between data marked in the loaded data link and a target point; and
obtaining the navigation point by taking each piece of position information corresponding to the information of the position to be located as a position identifier.

3. The method of claim 2, wherein the information of the position to be located comprises at least one of marked position information, position information of a list data group or recommended position information.

4. The method of claim 3, wherein when the information of the position to be located is the marked position information, before obtaining the information of the position to be located, the method further comprises:
displaying marking controls at a corresponding position of each datum in the loaded data link on the display interface;
correspondingly, obtaining the information of the position to be located comprises:
when a triggering operation acting on at least one of the marking controls is received, obtaining at least one corresponding marked datum according to at least one of the triggering operations; and
taking the distance between the at least one marked datum and the target point as the marked position information; and
taking the marked position information as the information of the position to be located.

5. The method of claim 3, wherein when the information of the position to be located is the position information of a list data group, before obtaining the information of the position to be located, the method further comprises:
dividing the list data into at least one group of data according to a preset loading rule;
correspondingly, obtaining the information of the position to be located comprises:
obtaining identification data of each group of data in the loaded data link;
taking the distance between the at least one of the identification data and the target point as the position information of a list data group; and
taking the position information of a list data group as the information of the position to be located.

6. The method of claim 3, wherein when the information of the position to be located is the recommended position information, obtaining the information of the position to be located comprises:
when a data loading request for the list data is received, obtaining feature information of a corresponding data requester;
obtaining list recommending position information corresponding to the list data by inputting the feature information of the data requester into a preset marking model, wherein the preset marking model is used for determining a position information of a recommended mark in the list data;
obtaining corresponding recommended data from the list recommending position information according to the loaded data link on the display interface;
taking the distance between the recommended data and the target point as the recommended position information; and
taking the recommended position information as the information of the position to be located.

7. The method of claim 6, wherein before obtaining the list recommending position information corresponding to the list data by inputting the feature information of the data requester into the preset marking model, the method further comprises:
obtaining historical mark information corresponding to the list data, wherein the historical mark information represents information associated with a historical marking operation acting on a marking control and corresponding to the list data;
obtaining, according to the historical marking information, corresponding historical marked position information and feature information of a marking participant; and
obtaining the preset marking model by training a model according to the historical marked position information and the feature information of the marking participant.

8. The method of claim 1, wherein after displaying the locating control, which is provided with the navigation point, at the first preset position on the display interface on which the list data is loaded, the method further comprises:
when a second locating operation acting on a non-navigational point of the locating control is received, determining a corresponding position of second data to be located in the loaded data link, wherein the non-navigational point represents information on a position on the locating control other than a navigation point; and
jumping to the position of the second data to be located on the display interface, and displaying the second data to be located corresponding to the position of the second data to be located to locate the second data to be located on the display interface.

9. The method of claim 8, wherein when the second locating operation is a first sliding operation, determining, when the second locating operation acting on the non-navigational point of the locating control is received, the corresponding position of the second data to be located in the loaded data link comprises:
when the first sliding operation acting on the non-navigational point of the locating control is received, determining a corresponding first data sliding track in the loaded data link, wherein the first data sliding track is the position of the second data to be located;
correspondingly, jumping to the position of the second data to be located on the display interface, and displaying the second data to be located corresponding to the position of the second data to be located to locate the second data to be located on the display interface comprises:
determining a data sliding start position and a data sliding end position of the first data sliding track; and
jumping to the data sliding start position on the display interface and sliding the data until the data reaches the data sliding end position, and displaying the second data to be located corresponding to the first data sliding track to locate the second data to be located on the display interface.

10. The method of claim 1, wherein after displaying the locating control, which is provided with the navigation point, at the first preset position on the display interface on which the list data is loaded, the method further comprises:
receiving a display operation acting on the navigation point; and
displaying a prompt box at a second preset position on the display interface according to the display operation, wherein the second preset position represents a position corresponding to the navigation point on the display interface, and the prompt box represents information of the loaded data link corresponding to the navigation point.

11. The method of claim 1, wherein after displaying the locating control, which is provided with the navigation point, at the first preset position on the display interface on which the list data is loaded, the method further comprises:
obtaining a second data sliding track of the loaded data link on the display interface;
determining a locating sliding track on the locating control according to the second data sliding track;
determining a locating sliding start position and a locating sliding end position of the locating sliding track; and
sliding a locating cursor on the locating control from the locating sliding start position to the locating sliding end position to slide proportionally to the second data sliding track.

12. The method of claim 2, wherein after obtaining the navigation point by taking each piece of position information corresponding to the information of the position to be located as a position identifier, the method further comprises:
when a number of the navigation points is greater than a preset number, selecting a preset number of navigation points from the navigation points for display, and hiding unselected navigation points in the navigation points, wherein the preset number is a set number of navigation points displayed on the locating control.

13. The method of claim 1, further comprising:
when function applying is performed, loading the display interface through the locating device.

14. A locating device comprising: a processor, a memory and a communication bus, wherein the memory is configured to communicate with the processor through the communication bus; the memory is configured to store a processor-executable program, the processor is configured to execute the processor-executable program to perform a method, the method comprising:
displaying a locating control, which is provided with a navigation point, at a first preset position on a display interface on which list data is loaded, wherein the navigation point represents an identifier corresponding to a position marked in a loaded data link in the list data;
when a first locating operation acting on the navigation point is received, determining a corresponding position of first data to be located in the loaded data link; and
jumping to the position of the first data to be located on the display interface, and displaying the first data to be located corresponding to the position of the first data to be located to locate the first data to be located on the display interface.

15. A non-transitory computer-readable storage medium having stored thereon a program that when executed by a processor, performs a method, the method comprising:
displaying a locating control, which is provided with a navigation point, at a first preset position on a display interface on which list data is loaded, wherein the navigation point represents an identifier corresponding to a position marked in a loaded data link in the list data;
when a first locating operation acting on the navigation point is received, determining a corresponding position of first data to be located in the loaded data link; and
jumping to the position of the first data to be located on the display interface, and displaying the first data to be located corresponding to the position of the first data to be located to locate the first data to be located on the display interface.

16. The locating device of claim 14, wherein before displaying the locating control, which is provided with the navigation point, at the first preset position on the display interface on which the list data is loaded, the method further comprises:
obtaining information of a position to be located, wherein the information of the position to be located represents a distance between data marked in the loaded data link and a target point; and
obtaining the navigation point by taking each piece of position information corresponding to the information of the position to be located as a position identifier.

17. The locating device of claim 16, wherein the information of the position to be located comprises at least one of marked position information, position information of a list data group or recommended position information.

18. The locating device of claim 17, wherein when the information of the position to be located is the marked position information, before obtaining the information of the position to be located, the method further comprises:
displaying marking controls at a corresponding position of each datum in the loaded data link on the display interface;
correspondingly, obtaining the information of the position to be located comprises:
when a triggering operation acting on at least one of the marking controls is received, obtaining at least one corresponding marked datum according to at least one of the triggering operations; and
taking the distance between the at least one marked datum and the target point as the marked position information; and
taking the marked position information as the information of the position to be located.

19. The locating device of claim 17, wherein when the information of the position to be located is the position information of a list data group, before obtaining the information of the position to be located, the method further comprises:
dividing the list data into at least one group of data according to a preset loading rule;
correspondingly, obtaining the information of the position to be located comprises:
obtaining identification data of each group of data in the loaded data link;
taking the distance between the at least one of the identification data and the target point as the position information of a list data group; and
taking the position information of a list data group as the information of the position to be located.

20. The locating device of claim 17, wherein when the information of the position to be located is the recommended position information, obtaining the information of the position to be located comprises:
when a data loading request for the list data is received, obtaining feature information of a corresponding data requester;
obtaining list recommending position information corresponding to the list data by inputting the feature information of the data requester into a preset marking model, wherein the preset marking model is used for determining a position information of a recommended mark in the list data;
obtaining corresponding recommended data from the list recommending position information according to the loaded data link on the display interface;
taking the distance between the recommended data and the target point as the recommended position information; and
taking the recommended position information as the information of the position to be located.
